(19) United States
(12) Patent Application Publication
(10) Pub. No.: US 2025/0291929 A1
(43) Pub. Date: Sep. 18, 2025

(54) IDENTIFYING AND HANDLING VULNERABLE INFORMATION IN LOG FILES USING LARGE LANGUAGE MODELS

(71) Applicant: T-Mobile USA, Inc., Bellevue, WA (US)

(72) Inventor: Jan Olav Opedal, Ellensburg, WA (US)

(21) Appl. No.: 18/604,091

(22) Filed: Mar. 13, 2024

(51) Int. Cl. G06F 21/57; G06F 40/20

(52) U.S. Cl. CPC G06F 21/577; G06F 40/20

(57) ABSTRACT

Various implementations generally relate to systems and methods for identifying and handling vulnerable information in log files of an enterprise, including receiving a first set of obfuscated log files from a log storage or an application that generated log files in the first set, and processing the first set of obfuscated log files using a large language model (LLM) to identify a subset of the first set of obfuscated log files that contain a vulnerability.

### BACKGROUND

A large language model (“LLM”) is a large-scale language model notable for its ability to achieve general-purpose language understanding and generation. LLMs acquire such ability by using massive amounts of data to learn billions of parameters during training and consuming large computational resources during their training and operation. LLMs are artificial neural networks and are trained using self-supervised learning and/or semi-supervised learning.

### BRIEF DESCRIPTION OF THE DRAWINGS

Detailed descriptions of implementations of the present invention will be described and explained through the use of the accompanying drawings.

FIG. 1 is a block diagram that illustrates an environment in which a vulnerability detection and mitigation system of a communications network performs detection and mitigation of vulnerabilities within the communications network, according to some implementations.

FIG. 2 is a block diagram illustrating functional modules executed by the vulnerability detection and mitigation system to detect a vulnerability in logfiles and take mitigating actions, according to some implementations.

FIG. 3 is a flowchart illustrating a process for identifying and handling vulnerable information in logfiles of a communications network, according to some implementations.

FIG. 4 is a block diagram that illustrates an example of a computer system in which at least some operations described herein can be implemented.

FIG. 5 is a block diagram of an example transformer that uses self-attention mechanisms to generate predicted output based on input data in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technologies address problems faced by communications networks in dealing with inefficiencies faced when reviewing log files and/or codebase of applications to identify and mitigate vulnerable data. Various implementations generally relate to systems and methods for identifying and handling vulnerable information in log files of an enterprise by processing a set of log files using a large language model (“LLM”) to identify a subset of the set containing a vulnerability and using the subset to identify the vulnerability in other sets of log files, eliminating the need to review log files in entirety and enabling efficient identification of vulnerable applications in the enterprise.

In some implementations, a vulnerability detection and mitigation system receives a first set of obfuscated log files and processes the first set of obfuscated log files using an LLM to identify a subset of the first set of obfuscated log files that contain a vulnerability. After identifying the subset, the vulnerability detection and mitigation system builds a regular expression (“regex”) used to identify the vulnerability in other sets of log files. The regex is applied to the first set of obfuscated log files to create first vector embeddings, and the regex is applied to a second set of obfuscated log files to create second vector embeddings. The vulnerability detection and mitigation system compares the first vector embeddings and the second vector embeddings using a distance algorithm to determine whether the vulnerability identified in the first set of obfuscated log files exists in the second set of obfuscated log files.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

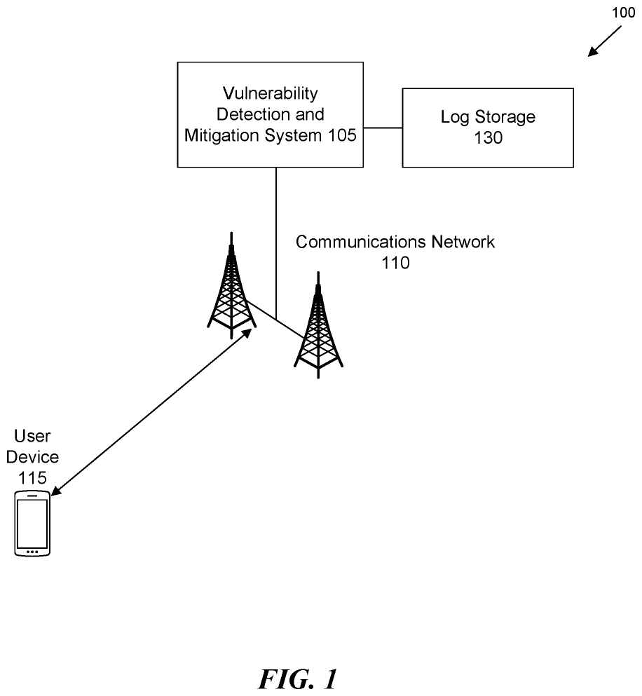

FIG. 1 is a block diagram that illustrates an environment 100 in which a vulnerability detection and mitigation system 105 of a communications network 110 performs detection and mitigation of vulnerabilities within the communications network, according to some implementations. As illustrated in FIG. 1, the environment 100 may include the communications network 110, a user device 115 (such as a mobile phone, tablet computer, desktop computer, wearable computing device, etc.) in which a user of the communications network 110 uses to access one or more applications, and log storage 130 in which usage information of the one or more applications are stored.

The communications network 110 includes one or more base stations, which is a type of network access node (“NAN”) that can also be referred to as a cell site, a base transceiver station, or a radio base station. The communications network 110 enables the vulnerability detection and mitigation system 105 to communicate with the user device 115 by transmitting and receiving data, requests, and commands. In some implementations, the communications network 110 includes multiple networks to facilitate communications between and among the multiple networks.

For example, the user device 115 can be configured to periodically send usage information and relevant logfiles to the vulnerability detection and mitigation system 105. Alternatively or additionally, the user device 115 can be configured to send the usage information and relevant logfiles upon request by the vulnerability detection and mitigation system 105. The usage information and relevant logfiles can include history of access requested by the user device 115 and corresponding actions performed by the communications network 110. The usage information and relevant logfiles can also include coding framework of the one or more applications and code documentation that includes codes associated with the one or more applications and textual explanations that describe the codes.

In some implementations, in addition to receiving the usage information and relevant logfiles from the user device 115, the vulnerability detection and mitigation system 105 is configured to access the log storage 130 in which usage information of the one or more applications are stored. The log storage 130 can be a database within the communications network 110 configured to store the usage information and relevant logfiles associated with the user device 115.

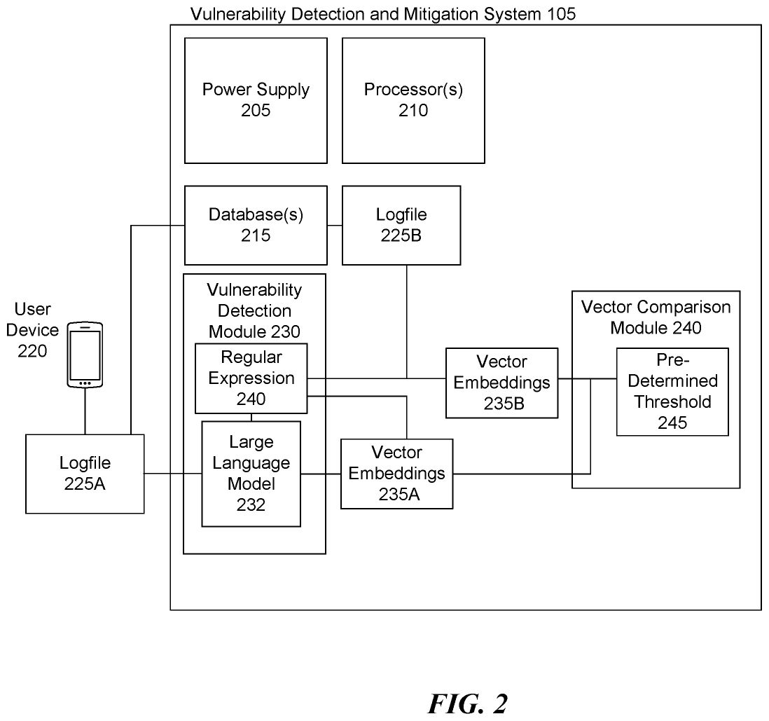

FIG. 2 is a block diagram illustrating functional modules executed by the vulnerability detection and mitigation system 105 to detect a vulnerability in logfiles and take mitigating actions, according to some implementations. As shown in FIG. 2, the vulnerability detection and mitigation system 105 includes a vulnerability detection module 230 and a vector comparison module 240. Other implementations of the vulnerability detection and mitigation system 105 include additional, fewer, or different modules or distribute functionality differently between the modules. As used herein, the term “module” refers broadly to software components, firmware components, and/or hardware components. Accordingly, the modules 230 and 240 could each be comprised of software, firmware, and/or hardware components implemented in, or accessible to, the vulnerability detection and mitigation system 105. The vulnerability detection and mitigation system 105 also includes power supply 205, one or more processors 210, and one or more databases 215 configured to store logfiles, such as logfiles 225A and 225B.

The process of determining if a logfile includes vulnerable data begins with the vulnerability detection and mitigation system 105 receiving a logfile 225A. The logfile 225A can be received from a user device 220, or the logfile 225A can be retrieved from the database 215. In some implementations, one or more applications installed in the user device 220 are configured to send logfiles including user interactions and/or codebase associated with the one or more applications to the database 215. The user device 220 can include any computing device within a communications network, such as a mobile phone or a SIM-enabled tablet computer or wearable device. The logfile 225A can be a log of usage information associated with the user device 220. The logfile 225A can also be a server log stored in the database 215 within the communications network.

In some implementations, the logfile 225A is received by the vulnerability detection and mitigation system 105 in response to a request by the vulnerability detection and mitigation system 105 to the use device 220 to send a log of usage information associated with the user device 220. In other implementations, the vulnerability detection and mitigation system 105 is configured to periodically receive logs of usage information from the user device 220.

After receiving the logfile 225A, the vulnerability detection and mitigation system 105 employs the vulnerability detection module 230 to analyze the logfile 225A to identify vulnerable data stored in the logfile 225A. The vulnerability detection module 230 includes or accesses a large language model (“LLM”) 232 which receives logfiles as input and outputs information associated with the logfiles upon receiving engineered prompts. The LLM 232 analyzes content stored in the logfiles and generates text-based content in response to the engineered prompts. The information associated with the logfiles can include content of the logfiles, security and/or vulnerability issues identified in each of the logfiles, and relative location of the identified security and/or vulnerability issues within each of the logfiles. The security and/or vulnerability issues can include, but are not limited to, login information, identification information associated with users accessing one or more applications when the logfiles were generated, and sensitive personal identifiable information such as unique customer numbers and social security numbers. One or more of the LLMs described herein can be trained or fine-tuned using training data that includes logfiles as input and a desired output, such as instances of vulnerability identified in the logfiles.

In some implementations, the engineered prompts can configure the LLM 232 to identify a subset of the logfile 225A that contain the security and/or vulnerability issues. By identifying the subset of the logfile 225A that contains the security and/or vulnerability issues, the LLM 232 increases efficiency of vulnerability identification and mitigation process because only relevant portions of the logfile 225A that contain the security and/or vulnerability issues are selected for review.

After identifying the subset of the logfile 225A that contains the security and/or vulnerability issues, the vulnerability detection module 230 can build a regular expression (“regex”) to be used for identifying similar security and/or vulnerability issues in other logfiles stored within the communications network such that each logfile does not need to be processed by an LLM. Regex, sometimes referred to as rational expression, is a sequence of characters that specifies a match pattern. In an example, after identifying that the subset of the logfile 225A contains “username2035” which is login information marked as a security issue, the vulnerability detection module 230 can build a regex to be used to identify portions of logfiles containing the character string “username2035.”

After building the regex associated with the identified subset of the logfile 225A containing the security and/or vulnerability issues, the vulnerability detection and mitigation system 105 can create vector embeddings 235A representing the subset of the logfile 225A in a vector space. The embeddings can be generated by a generative artificial intelligence model, such as a generative text model, that processes logfiles or portions of logfiles to produce an embedding to represent each logfile in the vector space. Alternatively, embeddings can be generated by other transformer-based models, neural networks, or other algorithms that receive elements of a logfile as input and generate a vector representation of the logfile based on the elements. The vector embeddings are created for efficient identification and comparison of security and/or vulnerability issues in other logfiles. The vector embeddings 235A can be inserted into a vector database that stores vector embeddings representing subsets of multiple logfiles.

In some implementations, the vulnerability detection and mitigation system 105 receives another logfile 225B. The logfile 225B can be received from the database 215. Alternatively, the logfile 225B can be received via the communications network from an application that generated the logfiles. After receiving the logfile 225B, the vulnerability detection and mitigation system 105 can apply the regex to the logfile 225B to identify a subset of the logfile 225B that match a sequence of characters specified in the regex. The vulnerability detection and mitigation system 105 can subsequently create vector embeddings 235B that represent the subset of the logfile 225B in the vector space.

After generating the vector embeddings 235A and 235B, the vulnerability detection and mitigation system 105 can employ the vector comparison module 240 to determine whether the security and/or vulnerability issues identified in the logfile 225A exist in the logfile 225B. The vector comparison module 240 compares the vector embeddings using a distance algorithm to make the determination. In some implementations, because the vector embeddings are only representative of the subset of the logfiles that contain the security and/or vulnerability issues and not the entire logfiles, the vector comparison process is efficient and eliminates the need to examine each logfile in its entirety for detection of security and/or vulnerability issues.

In some implementations, the distance algorithm is a cosine approach wherein the vector comparison module 240 calculates a cosine similarity between the vector embeddings. After calculating the cosine similarity, the cosine similarity is compared to a pre-determined threshold 245 set by the vulnerability detection and mitigation system 105. Upon determining that the cosine similarity between the vector embeddings exceeds the pre-determined threshold 245, the vector comparison module 240 can determine that the security and/or vulnerability issues identified in the logfile 225A exists in the logfile 225B.

After determining that the security and/or vulnerability issues identified in the logfile 225A exists in the logfile 225B, the vulnerability detection and mitigation system 105 can be configured to notify a network node or an administrator within the communications network responsible for storing the logfile 225B or handling the application that generated the logfile 225B.

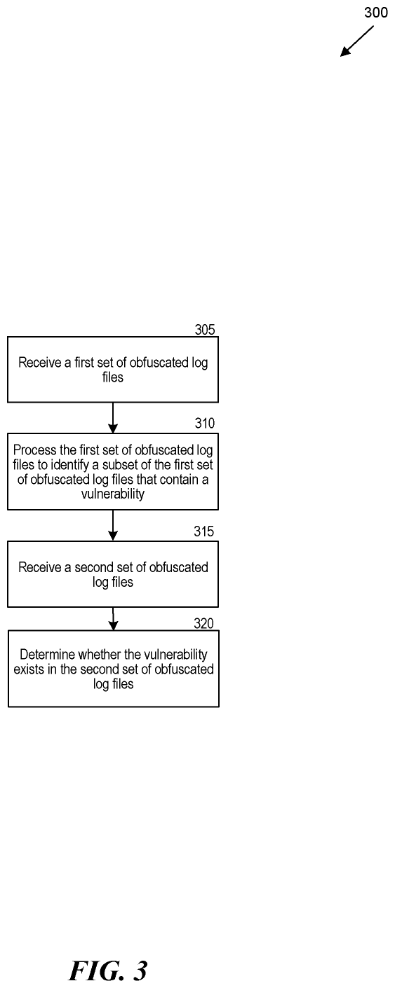

FIG. 3 is a flowchart illustrating a process 300 for identifying and handling vulnerable information in logfiles of a communications network, according to some implementations. The process 300 can be performed by the vulnerability detection and mitigation system 105, in some implementations. Other implementations of the process 300 include additional, fewer, or different steps or performing the steps in different orders.

In step 305, the vulnerability detection and mitigation system 105 receives a first set of obfuscated log files from a log storage or an application that generated log files in the first set of obfuscated log files. Because the log files are obfuscated, contents of the log files are not readily readable. Examples of the obfuscated log files include, but are not limited to, logs generated based on interactions between a user device and the application, server logs saved in the log storage of the communications network, codebase of the application, or source files of the application.

In step 310, in response to receiving the first set of obfuscated log files, the vulnerability detection and mitigation system 105 processes the first set of obfuscated log files using an LLM to identify a subset of the first set of obfuscated log files that contain a vulnerability. Processing the first set of obfuscated log files can include applying engineered prompts to the log files in the first set of obfuscated log files to identify the contents of the first set of obfuscated log files.

In some implementations, the vulnerability detection and mitigation system 105 prompts the LLM to determine contents stored in the first set of obfuscated log files or identify a security issue or a vulnerability in the first set of obfuscated log files. For example, in response to a prompt by the vulnerability detection and mitigation system 105 to identify a security issue or a vulnerability in the first set of obfuscated log files, the LLM can identify a subset of the first set of obfuscated log files that contain the security issue or the vulnerability. Examples of security and/or vulnerability issues include, but are not limited to, login information, identification information associated with users accessing one or more applications when the logfiles were generated, unique customer numbers, social security numbers, or other personal identifiable information that are identified in the first set of obfuscated log files.

The vulnerability detection and mitigation system 105 can be further configured to build a regex to be used for identifying similar security and/or vulnerability issues in other log files stored within the communications network. The regex can specify sequences of characters indicating the security issue or the vulnerability that have been identified in the subset of the first set of obfuscated log files. Additionally, the vulnerability detection and mitigation system 105 can create first embeddings in a vector space by identifying portions of the first set of obfuscated log files that match the regex. The first embeddings therefore represent the subset of the first set of obfuscated log files that contain the security issue or the vulnerability.

In step 315, the vulnerability detection and mitigation system 105 receives a second set of obfuscated log files. In some implementations, in response to receiving the second set of obfuscated log files, the vulnerability detection and mitigation system 105 can apply the regex to the second set of obfuscated log files to identify a subset of the second set of obfuscated log files that match the regex. The vulnerability detection and mitigation system 105 can subsequently create second embeddings representing the subset of the second set of obfuscated log files in the vector space.

In step 320, the vulnerability detection and mitigation system 105 determines whether the vulnerability identified in the first set of obfuscated log files exists in the second set of obfuscated log files. The identification can be done based on comparing the first embeddings and the second embeddings representing subsets of the obfuscated log files that match the regex. A distance algorithm, such as a cosine approach, can be used to determine a cosine similarity between the first embeddings and the second embeddings. After determining the cosine similarity, the cosine similarity can be compared to a pre-determined threshold set by the vulnerability detection and mitigation system 105. Upon determining that the cosine similarity between the first embeddings and the second embeddings exceeds the pre-determined threshold, the vulnerability detection and mitigation system 105 may determine that the vulnerability identified in the first set of obfuscated log files exists in the second set of obfuscated log files.

In some implementations, upon determining that the vulnerability identified in the first set of obfuscated log files exists in the second set of obfuscated log files, the vulnerability detection and mitigation system 105 is configured to send a notification to a network node or an administrator responsible for maintaining storage of the second set of obfuscated log files or handling the application that generated the second set of obfuscated log files, enabling the node or administrator to modify the storage or application to remove vulnerabilities.

### Computer System

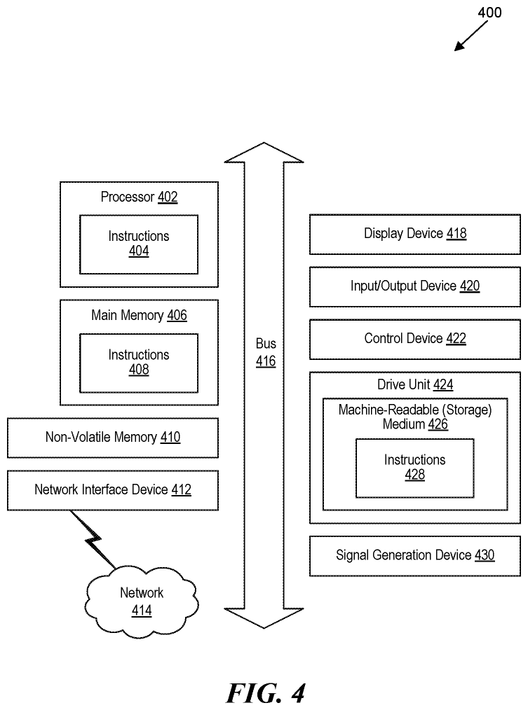

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, video display device 418, an input/output device 420, a control device 422 (e.g., keyboard and pointing device), a drive unit 424 that includes a storage medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

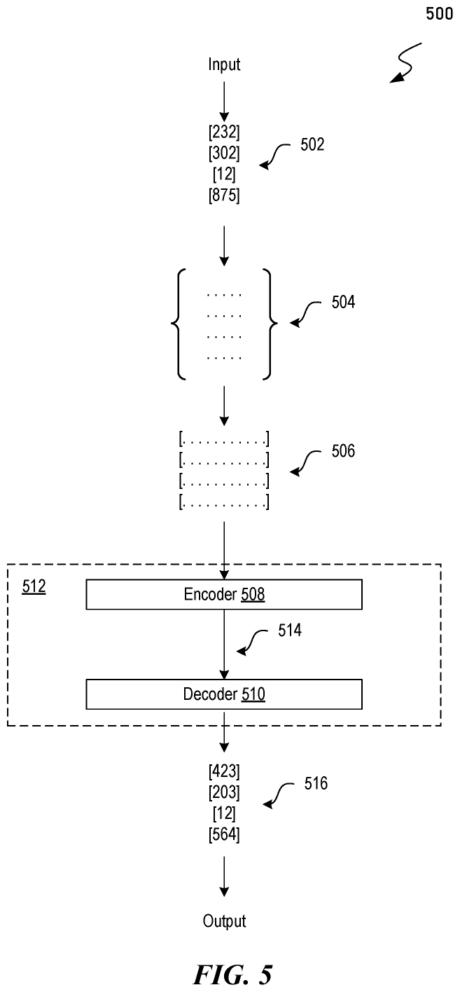

FIG. 5 is a block diagram of an example transformer 512. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 512 includes an encoder 508 (which can comprise one or more encoder layers/blocks connected in series) and a decoder 510 (which can comprise one or more decoder layers/blocks connected in series). Generally, the encoder 508 and the decoder 510 each include a plurality of neural network layers, at least one of which can be a self-attention layer. The parameters of the neural network layers can be referred to as the parameters of the language model.

The transformer 512 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 512 is trained to perform certain functions on other input formats than natural language input. For example, the input can include objects, images, audio content, or video content, or a combination thereof.

The transformer 512 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 5 illustrates an example of how the transformer 512 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 5, a short sequence of tokens 502 corresponding to the input text is illustrated as input to the transformer 512. Tokenization of the text sequence into the tokens 502 can be performed by some pre-processing tokenization module such as, for example, a byte-pair encoding tokenizer (the “pre” referring to the tokenization occurring prior to the processing of the tokenized input by the LLM), which is not shown in FIG. 5 for simplicity. In general, the token sequence that is inputted to the transformer 512 can be of any length up to a maximum length defined based on the dimensions of the transformer 512. Each token 502 in the token sequence is converted into an embedding vector 506 (also referred to simply as an embedding 506). An embedding 506 is a learned numerical representation (such as, for example, a vector) of a token that captures some semantic meaning of the text segment represented by the token 502. The embedding 506 represents the text segment corresponding to the token 502 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 506 corresponding to the “write” token will be closer to another embedding corresponding to the “jot down” token in the vector space as compared to the distance between the embedding 506 corresponding to the “write” token and another embedding corresponding to the “summary” token.

The vector space can be defined by the dimensions and values of the embedding vectors. Various techniques can be used to convert a token 502 to an embedding 506. For example, another trained ML model can be used to convert the token 502 into an embedding 506. In particular, another trained ML model can be used to convert the token 502 into an embedding 506 in a way that encodes additional information into the embedding 506 (e.g., a trained ML model can encode positional information about the position of the token 502 in the text sequence into the embedding 506). In some examples, the numerical value of the token 502 can be used to look up the corresponding embedding in an embedding matrix 504 (which can be learned during training of the transformer 512).

The generated embeddings 506 are input into the encoder 508. The encoder 508 serves to encode the embeddings 506 into feature vectors 514 that represent the latent features of the embeddings 506. The encoder 508 can encode positional information (i.e., information about the sequence of the input) in the feature vectors 514. The feature vectors 514 can have very high dimensionality (e.g., on the order of thousands or tens of thousands), with each element in a feature vector 514 corresponding to a respective feature. The numerical weight of each element in a feature vector 514 represents the importance of the corresponding feature. The space of all possible feature vectors 514 that can be generated by the encoder 508 can be referred to as the latent space or feature space.

Conceptually, the decoder 510 is designed to map the features represented by the feature vectors 514 into meaningful output, which can depend on the task that was assigned to the transformer 512. For example, if the transformer 512 is used for a translation task, the decoder 510 can map the feature vectors 514 into text output in a target language different from the language of the original tokens 502. Generally, in a generative language model, the decoder 510 serves to decode the feature vectors 514 into a sequence of tokens. The decoder 510 can generate output tokens 516 one by one. Each output token 516 can be fed back as input to the decoder 510 in order to generate the next output token 516. By feeding back the generated output and applying self-attention, the decoder 510 is able to generate a sequence of output tokens 516 that has sequential meaning (e.g., the resulting output text sequence is understandable as a sentence and obeys grammatical rules). The decoder 510 can generate output tokens 516 until a special [EOT] token (indicating the end of the text) is generated. The resulting sequence of output tokens 516 can then be converted to a text sequence in post-processing. For example, each output token 516 can be an integer number that corresponds to a vocabulary index. By looking up the text segment using the vocabulary index, the text segment corresponding to each output token 516 can be retrieved, the text segments can be concatenated together, and the final output text sequence can be obtained.

In some examples, the input provided to the transformer 512 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Remarks

The terms “example,” “embodiment,” and “implementation” are used interchangeably. For example, references to “one example” or “an example” in the disclosure can be, but are not necessarily, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or they can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

1. A method for identifying and handling vulnerable information in log files of an enterprise, the method comprising:
receiving a first set of obfuscated log files from a log storage or an application that generated log files in the first set; and
processing the first set of obfuscated log files using a large language model (LLM) to identify a subset of the first set of obfuscated log files that contain a vulnerability,
wherein processing the first set of obfuscated log files using the LLM comprises applying engineered prompts to the log files in the first set to identify contents of the first set of obfuscated log files;
creating first embeddings representing the subset of the first set of obfuscated log files in a vector space and inserting the first embeddings into a vector database;
receiving a second set of log files from the log storage or an application that generated log files in the second set;
creating second embeddings representing the second set of log files in the vector space and inserting the second embeddings into the vector database; and
comparing the first embeddings and the second embeddings using a distance algorithm to determine whether the vulnerability exists in the second set of log files.

2. The method of claim 1, further comprising:
based on identifying the subset, building a regular expression (“regex”) to be used for identifying the vulnerability in other sets of log files of the enterprise.

3. The method of claim 2, further comprising:
applying the regex to the second set of log files to identify a subset of the second set of log files that match the regex;
wherein creating the second embeddings representing the second set of log files comprises creating embeddings for the identified subset of the second set.

4. The method of claim 1, further comprising:
upon determining the vulnerability exists in the second set of log files, notifying a network node responsible for maintaining the log storage or handling the application that generated the second set of log files.

5. The method of claim 1, wherein comparing the first embeddings and the second embeddings comprises:
calculating a cosine similarity between the first embeddings and the second embeddings;
comparing the cosine similarity to a pre-determined threshold; and
upon determining that the cosine similarity between the first embeddings and the second embeddings exceeds the pre-determined threshold, determining the vulnerability identified in the first set of obfuscated log files exists in the second set of log files.

6. The method of claim 1, wherein the vulnerability includes at least one of: login information, unique customer identifier, social security number, or personal identifiable information.

7. The method of claim 1, wherein the obfuscated log files include at least one of: logs generated based on interactions between a user device and the application, server logs saved in the log storage of the enterprise, codebase of the application, or source files of the application.

8. A system for identifying and handling vulnerable information in log files of an enterprise, the system comprising:
at least one hardware processor; and
at least one non-transitory memory storing instructions, which, when executed by the at least one hardware processor, cause the system to:
receive a first set of log files from a log storage or an application that generated log files in the first set; and
process the first set of log files using a large language model (LLM) to identify a subset of the first set of log files that contain a vulnerability,
wherein processing the first set of log files using the LLM comprises applying engineered prompts to the log files in the first set to identify contents of the first set of log files
create first embeddings representing the subset of the first set of log files in a vector space and inserting the first embeddings into a vector database;
receiving a second set of log files from the log storage or an application that generated log files in the second set;
creating second embeddings representing the second set of log files in the vector space and inserting the second embeddings into the vector database; and
comparing the first embeddings and the second embeddings using a distance algorithm to determine whether the vulnerability exists in the second set of log files.

9. The system of claim 8, wherein the instructions further cause the system to:
based on identifying the subset, build a regular expression (“regex”) to be used for identifying the vulnerability in other sets of log files of the enterprise.

10. The system of claim 9, wherein the instructions further cause the system to:
apply the regex to the second set of log files to identify a subset of the second set of log files that match the regex,
wherein creating the second embeddings representing the second set of log files comprises creating embeddings for the identified subset of the second set.

11. The system of claim 8, wherein the instructions further cause the system to:
upon determining the vulnerability exists in the second set of log files, notify a network node responsible for maintaining the log storage or handling the application that generated the second set of log files.

12. The system of claim 8, wherein comparing the first embeddings and the second embeddings comprises:
calculating a cosine similarity between the first embeddings and the second embeddings;
comparing the cosine similarity to a pre-determined threshold; and
upon determining that the cosine similarity between the first embeddings and the second embeddings exceeds the pre-determined threshold, determining the vulnerability identified in the first set of log files exists in the second set of log files.

13. The system of claim 8, wherein the vulnerability includes at least one of: login information, unique customer identifier, social security number, or personal identifiable information.

14. The system of claim 8, wherein the log files include at least one of: logs generated based on interactions between a user device and the application, server logs saved in the log storage of the enterprise, codebase of the application, or source files of the application.

15. A non-transitory, computer-readable storage medium storing executable instructions, the instructions, when executed by one or more processors, cause the one or more processors to:
receive a first set of log files from a log storage or an application that generated log files in the first set; and
process the first set of log files using a large language model (LLM) to identify a subset of the first set of log files that contain a vulnerability,
wherein processing the first set of log files using the LLM comprises applying engineered prompts to the log files in the first set to identify contents of the first set of log files
create first embeddings representing the subset of the first set of log files in a vector space and inserting the first embeddings into a vector database;
receive a second set of log files from the log storage or an application that generated log files in the second set;
create second embeddings representing the second set of log files in the vector space and inserting the second embeddings into the vector database; and
compare the first embeddings and the second embeddings using a distance algorithm to determine whether the vulnerability exists in the second set of log files.

16. The non-transitory, computer-readable storage medium of claim 15, wherein the instructions further cause the one or more processors to:
based on identifying the subset, build a regular expression (“regex”) to be used for identifying the vulnerability in other sets of log files.

17. The non-transitory, computer-readable storage medium of claim 16, wherein the instructions further cause the one or more processors to:
apply the regex to the second set of log files to identify a subset of the second set of log files that match the regex,
wherein creating the second embeddings representing the second set of log files comprises creating embeddings for the identified subset of the second set.

18. The non-transitory, computer-readable storage medium of claim 15, wherein the instructions further cause the one or more processors to:
upon determining the vulnerability exists in the second set of log files, notify a network node responsible for maintaining the log storage or handling the application that generated the second set of log files.

19. The non-transitory, computer-readable storage medium of claim 15, wherein comparing the first embeddings and the second embeddings comprises:
calculating a cosine similarity between the first embeddings and the second embeddings;
comparing the cosine similarity to a pre-determined threshold; and
upon determining that the cosine similarity between the first embeddings and the second embeddings exceeds the pre-determined threshold, determining the vulnerability identified in the first set of log files exists in the second set of log files.

20. The non-transitory, computer-readable storage medium of claim 15, wherein the vulnerability includes at least one of: login information, unique customer identifier, social security number, or personal identifiable information.
